(19) United States
(12) Patent Application Publication
(10) Pub. No.: US 2025/0178665 A1
(43) Pub. Date: Jun. 5, 2025

(54) Method for Operating a Steer-by-Wire Steering System

(71) Applicant: Robert Bosch GmbH, Stuttgart (DE)

(72) Inventor: Tobias Buchmann, Schwaebisch Gmuend (DE)

(21) Appl. No.: 18/954,276

(22) Filed: Nov. 20, 2024

(30) Foreign Application Priority Data
Dec. 4, 2023 (DE) 10 2023 212 138.7

(51) Int. Cl. B62D 6/00; B62D 5/04

(52) U.S. Cl. CPC B62D 6/008; B62D 5/0463

(57) ABSTRACT

A method is for operating a steer-by-wire steering system in a vehicle. The steer-by-wire steering system includes a feedback actuator associated with a steering handle and a steering actuator. During operation of the vehicle, a first signal, which carries operational state information, is generated and transmitted to the steering handle via the feedback actuator as feedback to the driver. The method also includes generating a second signal, that carries information regarding the driver's responsibility for the operation. The second signal is also transmitted to the steering handle by the feedback actuator as feedback to the driver.

This application claims priority under 35 U.S.C. § 119 to patent application no. DE 10 2023 212 138.7, filed on Dec. 4, 2023 in Germany, the disclosure of which is incorporated herein by reference in its entirety.

The disclosure relates to a method for operating a steer-by-wire steering system and an arrangement for carrying out the method.

### BACKGROUND

A steer-by-wire steering system foresees that a steering command is only electrically passed from a sensor to an electromechanical actuator that executes the steering command, via one or more control devices. Such steering regularly comprises a feedback unit, e.g. a steering wheel actuator, a steering actuator, for example in the form of a rack actuator, and a unit for evaluating and calculating signals that are implemented, for example, in software or in software functions.

The method presented is particularly used in a vehicle that can achieve different levels of automation, for example, as defined in SAE International J3016.

Vehicles typically distinguish between assisted, automated, and autonomous driving. The degree of automation is determined by the automation extent or the level of automation. These levels are:
Level 0 self-driver, the driver is driving himself,
Level 1 assisted mode, certain assistance systems help with vehicle operation, e.g. a distance-regulated cruise control,
Level 2 assisted mode, use of semi-automated functions, such as automatic parking, staying the lane,
Level 3 automated mode, the driver does not have to constantly monitor the system, the vehicle independently performs functions, e.g. lane change and staying in the lane,
level 4 autonomous mode, high automation, the guidance of the vehicle is permanently taken over by the system,
Level 5 autonomous mode, full automation, no driver required.

When implementing different degrees or levels of automation, it should be noted that the driver should have an appropriate level of confidence in the automation function. Too much trust leads to an increased risk of accidents, too little trust causes too little system utilization and may result in the system not being used at all. It should be noted that the driver should be willing to at least temporarily give up control of the vehicle at an automation level of greater than 3 (≥L3). To this end, the driver must be able to recognize or distinguish which level he or the vehicle is in. Likewise, a change in level must be clearly recognizable. Without these conditions, the driver cannot have the appropriate level of confidence to use the particular function as intended.

In principle, the aim is to provide the driver with information as quickly as possible about the current or directly impending driving condition, regardless of use in an automated vehicle.

### SUMMARY

Given this background, a method and an arrangement will be presented.

A method for operating a steer-by-wire steering system in a vehicle is presented, wherein the steer-by-wire steering system includes a feedback actuator, e.g. a steering wheel actuator associated with a steering wheel and a steering actuator, e.g., in the form of a rack actuator. During operation of the vehicle, a first signal carrying information on at least one operating state, for example a road condition and/or steering state is generated and transmitted to the steering handle via the feedback actuator, e.g. the steering wheel, as feedback to the driver. The driver gets a feel for the road in this way, as he is used to with a conventional steering system.

Furthermore, a second signal is generated that carries information regarding the driver's responsibility for the operation. This second signal is also transmitted via the feedback actuator to the steering handle, e.g., the steering wheel, as feedback to the driver. The second signal is thus overlaid onto the first signal, wherein the second signal may be produced in a manner that is not necessarily continuous, but also as needed. As an alternative, the generation of the first signal may be stopped at least temporarily at the same time or immediately before or after the second signal is generated.

The feedback actuator generates the steering feel and delivers the driver's wire-based or by-wire steering signal to the steering actuator that steers the wheels, depending on the travel speed and travel conditions.

In the following sections, the use of the method presented in connection with driving is discussed at different levels of automation. The level of automation directly affects the level of accountability of the driver for operation of the vehicle. However, the method is not limited to applications in the area of assisted or automated driving, but is also applicable to vehicles without further driver assistance systems as long as they have steer-by-wire steering.

The method presented relies, among other things, on building confidence in an automated system by achieving a clear distinction between different degrees of automation via familiar haptics that are noticeable on the feedback actuator. In this way, a lack of use of system functions can be countered.

The described arrangement is configured to perform the method presented here. This arrangement can be implemented in hardware and/or software. Furthermore, the arrangement can be integrated into a control unit of a vehicle or can be designed as such a control unit. In this arrangement, an evaluation unit is typically provided, for example, which is configured to determine and output signals based on received information.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the disclosure.

### BRIEF DESCRIPTION OF THE DRAWINGS

FIG. 1 shows a flow chart of a possible sequence of the presented method; and

FIG. 2 shows a schematic, highly simplified representation of a vehicle with an embodiment of the described arrangement for carrying out the presented method.

### DETAILED DESCRIPTION

The disclosure is illustrated schematically by means of embodiments in the drawings and is described in detail below with reference to the drawings.

The presented method foresees that the driver is provided feedback on the activation of a travel function greater than or equal to L3 via the feedback actuator, e.g. a steering wheel actuator, as a feedback unit. This may mean that mechanical behavior is specifically simulated to the driver by the feedback actuator. The driver can be provided with a familiar, intuitively recognizable feeling, for example clicking or snapping into place, which can be clearly felt with the steering handle. The change in the driving mode will be unambiguously clear to the driver in this way and he will be encouraged to hand over responsibility from this point onward or to take back responsibility if necessary.

By increasing the distinctness of separation between the levels of automation, a building of appropriate driver confidence and vehicle automation capability is encouraged.

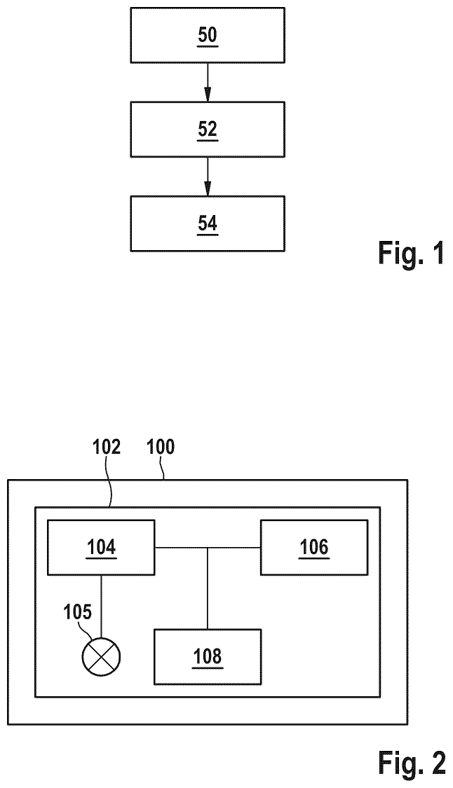

FIG. 1 shows a flow chart of a possible sequence of the presented method. In a first step 50, travel of a vehicle having a steer-by-wire steering system and having the ability to operate at different levels of automation begins. Travel begins at a level less than L3. At a later time, in a step 52, the vehicle will achieve level L3. This change in the level of automation is communicated to the driver in step 54 by means of the feedback actuator. This information is haptically transmitted to the driver via a conveyed feeling. The driver is able to adjust to the new situation and has confidence in the safe operation of the vehicle.

The torque required for synthetically generating the feeling is output only to the feedback actuator, but is not passed on to the wheels via the steering actuator.

The haptics of the simulated feeling can be variable and adjusted via the software menu. The effect can be calculated based on the current travel situation in the control unit of the vehicle, for example a steering control unit, and the regularly provided feedback or feedback signal. If it is foreseen for functionality at a level greater than or equal to L3 that the steering handle is stationary or stowed, e.g., folded away or lowered, the generated feeling may also limit rendering of the regular feedback signal.

Specific possible effects for modifying the movement of the feedback actuator include, for example:
delaying clicking in of the feedback actuator at a position once the automation function
becomes active by 0.5-1 s:
1) according to the feeling of locking, e.g. comparable to a door lock,
2) according to the feeling of approaching a magnet,
3) according to the feeling of pressing down a spring lock button, known from lockable telescopic rods, for example.

Additional signatures are also conceivable that are associated with locking in, snapping in or magnetic attraction. Effects that provide the most familiar haptic impressions to most people support intuitive use of the automation function and un (sub) consciously build trust in the system according to its performance.

When the automation function is terminated by a planned transfer scenario, a comparable or also inverse effect can be output via the feedback actuator. In this way, the driver can be clearly told that he is again responsible from this point onward. If necessary, the transition can be made by a subsequent blending or phasing in of the regular steering sensation during an assisted transition period.

In addition to switching between automation levels, it is also conceivable to use a corresponding effect with other, basically different types of use of the feedback actuator. An example of this is a switch between a game function and normal driving operation. If there is a change between driving and game operation, the driver's responsibility will also change.

The signature or the torque/angle characteristic curve of the aforementioned effects can be determined via a torque/angle sensor installed in a device equipped with the abovenamed components.

A purely synthetic mapping by mathematically deriving and/or reading from a mechanical device is also conceivable. In practice, a mixed form could prove to be practical, i.e., reading in using a torque sensor and mapping the determined characteristic curve as a mathematical function.

Known mathematical functions can be selected for this purpose that replicate the entire characteristic curve as well as possible.

The characteristic curve created in this way can be changed and optimized via several parameters. A plurality of options can also be implemented for the end user, which can be selected, for example, via the app or vehicle menu, e.g.:
a) angular range over which the snapping feeling occurs,
b) strength of the effect or amount of torque,
c) hardness of the effect, i.e. soft or hard clicking, which is optionally achievable by variations in the 1st and/or the 2nd derivation of the torque function.

It is important that feedback on changing an automation level is conveyed as torque via the feedback actuator, whereby a familiar haptic is synthesized. It is also important that the wheel impact does not change. The feeling to be conveyed can thereby be presented significantly more precisely than before, e.g., by vibrations.

The method presented has, at least in some embodiments, a number of advantages:
low-cost, can exclusively be implemented in software,
savings potential by avoiding additional feedback actuators, such as vibration,
improving ride comfort,
can be varied and personalized, e.g., via app,
development of new business models, e.g., subsequent activation, rental model,
differentiation from competition,
retrofitting capability (firmware over the air: FOTA),
gain end-user confidence by clearly differentiating automation levels, thereby increasing the frequency of use of the assisted automation function/increase system attractiveness.

The method may generally be employed in all steer-by-wire steering systems that have a feedback unit, such as the feedback actuator, and that are installed in vehicles that have automation functions, for example greater than or equal to L3.

FIG. 2 shows a schematic representation of a vehicle, which is denoted overall by reference number 100. This vehicle has a steer-by-wire steering system 102 with a feedback actuator 104 associated with steering handle 105 and a steering actuator 106, as well as an arrangement 108 for performing the method presented. This arrangement 108 is implemented by, for example, software functions.

Furthermore, the vehicle 100 is configured to achieve different levels of automation. The arrangement 108 may now generate, depending on the pending or impending change of the automation level, a signal that carries information about it and is passed to the feedback actuator 104, which takes this signal, or the information transmitted therewith, into account when providing feedback to the driver.

This feedback may provide a latching feeling, that is clicking in or out of the steering handle 105 with respect to a position.

What is claimed is:

1. A method of operating a steer-by-wire steering system in a vehicle, the steer-by-wire steering system comprising a feedback actuator associated with a steering handle and a steering actuator, the method comprising:
during operation of the vehicle, generating and transmitting a first signal carrying information about at least one operating state to the steering handle by the feedback actuator as feedback to a driver of the vehicle;
generating a second signal that carries information regarding a responsibility of the driver for the operation; and
transmitting the second signal to the steering handle by the feedback actuator as feedback to the driver.

2. The method according to claim 1, wherein the first signal carries information relating to a steering state of the vehicle and/or a road condition.

3. The method according to claim 1, wherein the second signal carries information based on a level of automation of the vehicle.

4. The method according to claim 3, wherein the second signal carries information related to a change in the level of automation.

5. The method according to claim 4, wherein the second signal carries information that the level of automation becomes greater than or equal to L3.

6. The method according to claim 4, wherein the second signal carries information that the level of automation becomes less than L3.

7. The method according to claim 1, wherein the feedback to the driver imparts a latching feeling to the steering handle with respect to a position.

8. The method according to claim 7, wherein the latching feeling includes snapping or clicking.

9. The method according to claim 1, wherein the feedback to the driver is adjusted.

10. The method according to claim 1, wherein:
the feedback to the driver is calculated in a vehicle control unit, and
the feedback to the driver is overlaid onto a feedback signal from the feedback actuator.

11. The method according to claim 10, wherein the vehicle control unit includes a steering control unit.

12. The method according to claim 1, wherein synthetic mapping of a signature representing the second signal is performed using mathematical derivation and/or reading from a mechanical device.

13. An arrangement for operating an automated vehicle, comprising:
an analysis unit,
wherein the arrangement is configured to carry out the method according to claim 1.
